(19) United States
(12) Patent Application Publication
(10) Pub. No.: US 2010/0096775 A1
(43) Pub. Date: Apr. 22, 2010

(54) MOLD IMPRINTING

(76) Inventor: Teng Hwee KOH, Singapore (SG)

Correspondence Address: HORIZON IP PTE LTD, 7500A Beach Road, #04-306/308 The Plaza, SINGAPORE 199591, SG

(21) Appl. No.: 12/580,275

(22) Filed: Oct. 16, 2009

Related U.S. Application Data
(60) Provisional application No. 61/106,132, filed on Oct. 16, 2008.

(51) Int. Cl. B29C 59/02

(52) U.S. Cl. 264/293; 425/385

(57) ABSTRACT

A method of patterning an article is disclosed. The method includes providing an article and providing a mold with first and second surfaces. The first surface includes a pattern. The method also includes providing a transfer medium between the mold and a surface of the article. The mold is pressed against the surface of the article with air pressure. A thickness of the mold enables the air pressure to cause the mold to contact the surface to produce an even pattern.

### BACKGROUND

Nanoimprint lithography has been investigated for various types of applications, such as fabricating semiconductor devices or magnetic disk media. In imprint lithography, a surface of a mold having a pattern with minimum feature size of, for example, below 50 nm is pressed against a surface of a substrate using a transfer medium, such as photoresist. The pattern of the mold is transferred to the photoresist on the substrate. However, conventional nanoimprint lithographic techniques result in features on the substrate being uneven, particularly when the imprint area is large. This can adversely impact manufacturing yields.

From the foregoing discussion, it is desirable to provide improved patterning of a substrate using imprint lithography.

### SUMMARY

A method of patterning an article is disclosed. The method includes providing an article and providing a mold with first and second surfaces. The first surface includes a pattern. The method also includes providing a transfer medium between the mold and a surface of the article. The mold is pressed against the surface of the article with air pressure. A thickness of the mold enables the air pressure to cause the mold to contact the surface to produce an even pattern.

In another embodiment, a method of patterning an article is presented. The method includes providing a substrate having a first surface and providing a mold with first and second surfaces. The first surface includes a pattern. A transfer medium is provided between the mold and a first surface. The mold is pressed against the first surface with air pressure. A thickness of the mold enables the air pressure to cause the mold to contact the first surface to produce an even pattern.

In yet another embodiment, a patterning system is disclosed. The system includes a first mold base having a first mating surface for mating to a first mold. The first mating surface includes first groove and hole pattern. The system also includes first air inlet coupled to the first groove and hole pattern. A second mold base having a second mating surface for mating to a second mold is also included. The second mating surface includes second groove and hole pattern. In addition, a second air inlet is coupled to the second groove and hole pattern. When air is supplied to the first and second inlets, the first and second groove and hole patterns generate a desired pressure profile on the first and second molds when mated to the first and second mating surfaces.

These and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

FIGS. 1a-d show various embodiments of transferring a pattern of a stamp onto an article;

FIGS. 2a-e show various mold units of a patterning system;

FIG. 3 shows an embodiment of an alignment unit;

FIGS. 4a-b show embodiments of a chuck;

FIGS. 5a-b show portions of a mold assembly in detail;

FIG. 6 shows an embodiment of a mold base;

FIGS. 7a-b show top and cross-sectional views of an embodiment of patterning system;

FIGS. 8a-b show top and cross-sectional views of an upper mold base assembly; and

FIGS. 9a-o show cross-sectional views of an embodiment of a patterning process 900.

### DESCRIPTION

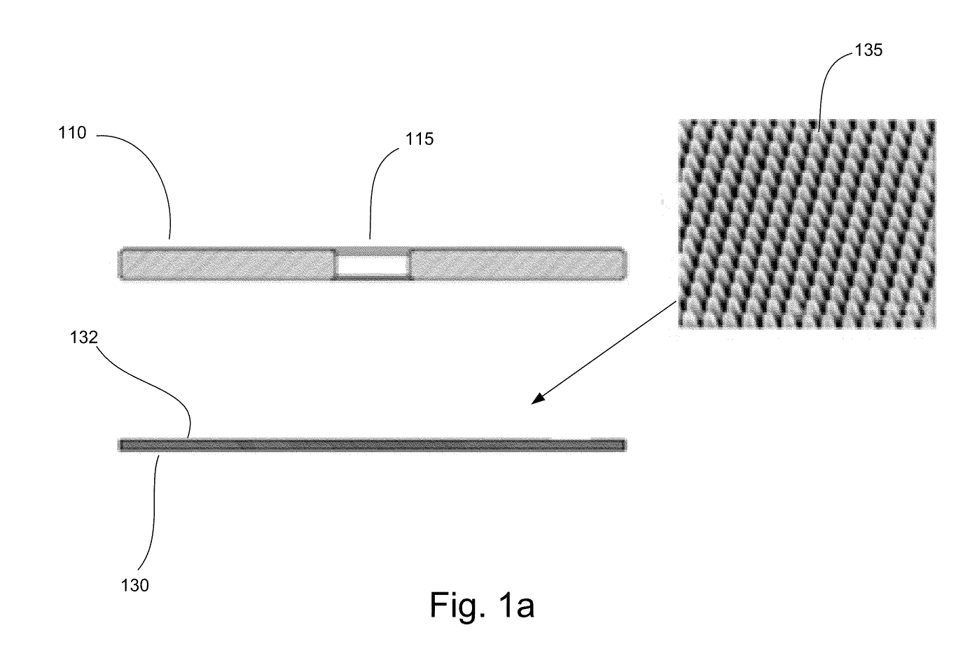

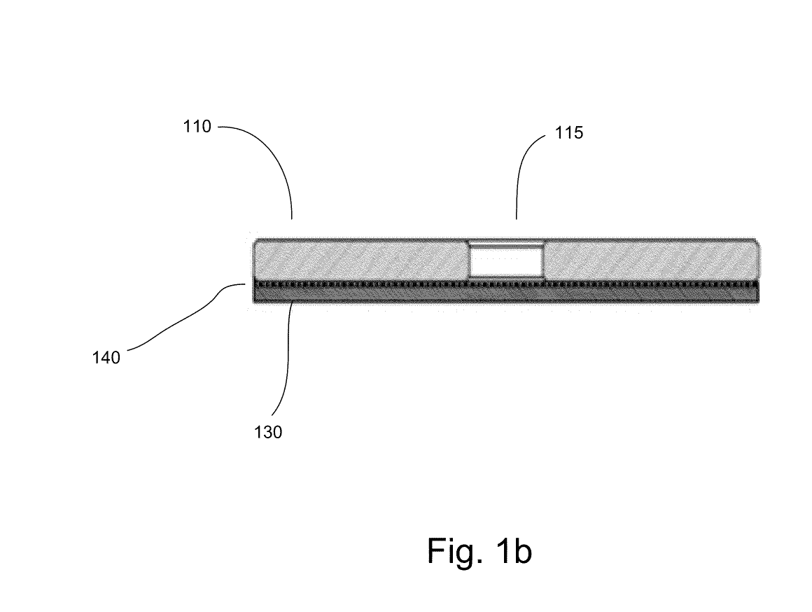

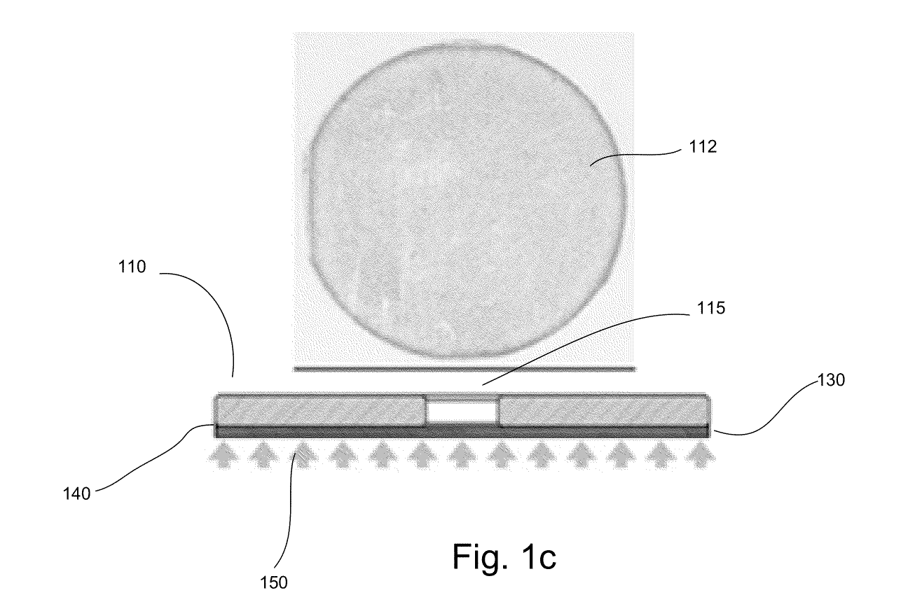

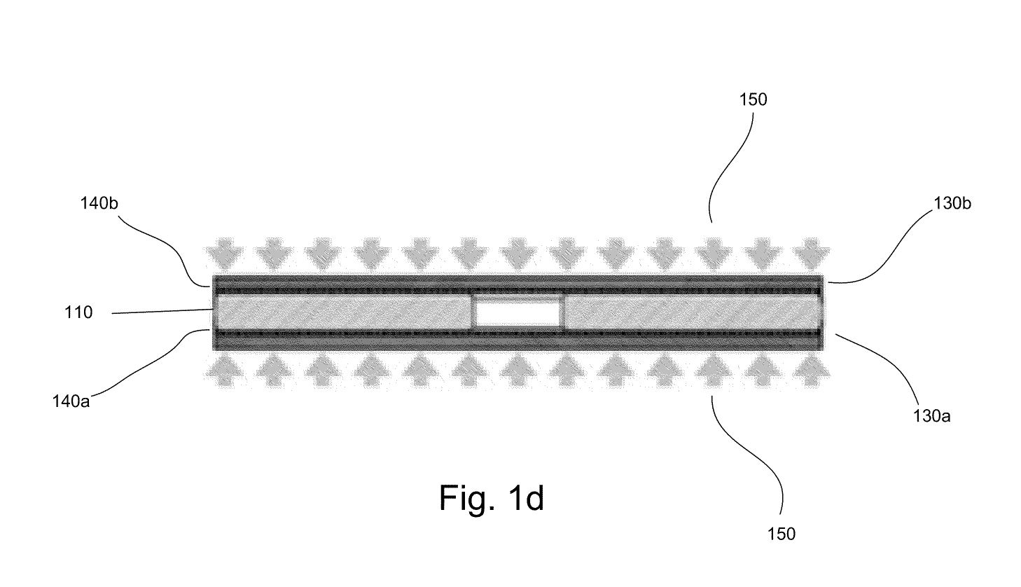

Embodiments generally relate to imprinting articles with a pattern from a mold or stamp. FIGS. 1a-b show an embodiment of transferring a pattern onto an article 110. In one embodiment, the article comprises a disk medium. An opening 115 is disposed at the center of the disk. The disk medium, for example, is used for storage of data. The disk media may be incorporated into a computer system or other types of consumer electronic products. Patterning other types of articles may also be useful. For example, the article may be a substrate or wafer used in forming semiconductor devices or integrated circuits (ICs).

A mold 130 is provided. The mold should be sufficiently flexible to enable it to conformally contact the surface of the article being imprinted. The mold, for example, has a thickness of about 0.6 mm. Other thicknesses for the mold may also be useful. For example, the mold can be formed of a polymer sheet. Other types of materials may also be useful. Preferably, the mold is formed of a transparent material, such as quartz. The use of a transparent material facilitates curing of the transfer medium used in the imprinting process. The mold includes a pattern 135 on a stamping surface 132. The pattern can be created using various patterning techniques, such as dry etching or laser etching. Other types of patterning techniques may also be useful.

The mold, for example, comprises a circular shape similar to that of the disk. Other geometric shapes are also useful. The mold should be at least the same size of the disk to pattern a surface of the disk completely. Preferably, the size of the mold should be larger than the disk. This allows more area for conformal contact and handling.

A dose of resist is disposed on, for example, stamping surface of the mold. Alternatively, the dose of resist is disposed on the surface of the disk. Disposing the resist on both the surface of the disk and mold may also be useful. In one embodiment, the resist is discretely disposed on the surface of the mold and/or disk. The droplet size of the resist, for example, is less than about 10 picoliter with a viscosity of less than about 10 cP. In one embodiment, the stamping surface is coated with an anti-adhesion material. This prevents the transfer medium from sticking to the mold after curing.

In FIG. 1b, the first major surface of the mold is pressed against one of the surface of the disk. When pressed against the surface of the disk, the resist spreads and forms a thin contiguous resist layer between the surface of the disk and mold. The resist is cured. In one embodiment, the resist is cured by UV. Other curing techniques may also be useful. Curing the resist hardens and causes it to adhere to the surface of the disk. The mold is released after curing, leaving the hardened resist layer on the surface of the disk with the pattern of the mold.

In one embodiment, the disk surface is provided with an adhesion promoter. The adhesion promoter, for example, comprises tantalum. The adhesion promoter can be provided after sputtering is performed to coat the disk with the magnetic layer. The adhesion promoter can be sputtered onto the disk. Alternatively, the adhesion promoter may be provided at other stage of processing. By using an adhesion promoter ensures adhesion of the transfer medium on the disk surface.

In one embodiment, as shown in FIG. 1c, the mold is pressed against the disk using air pressure 150. For example, air pressure is applied to the back surface (non-stamping surface) of the mold. The air pressure is applied across the back surface of mold to ensure that the stamping surface fully contacts the surface of the disk. This produces an even pattern 112 on the surface of the disk.

FIG. 1d shows another embodiment of transferring a pattern onto a disk 110. As shown, first and second molds 130a-b are provided for patterning first and second surfaces of the disk. Resist 140a-b is disposed on the stamping surface and/or disk surface. The molds are pressed against respective surfaces of the disk using, in one embodiment, air pressure 150. The resist is cured, thus transferring the pattern of the molds to the surfaces of disk. Imprinting both sides of the disk simultaneously advantageously increases throughput and reliability by avoiding damage from handling due to printing sides sequentially.

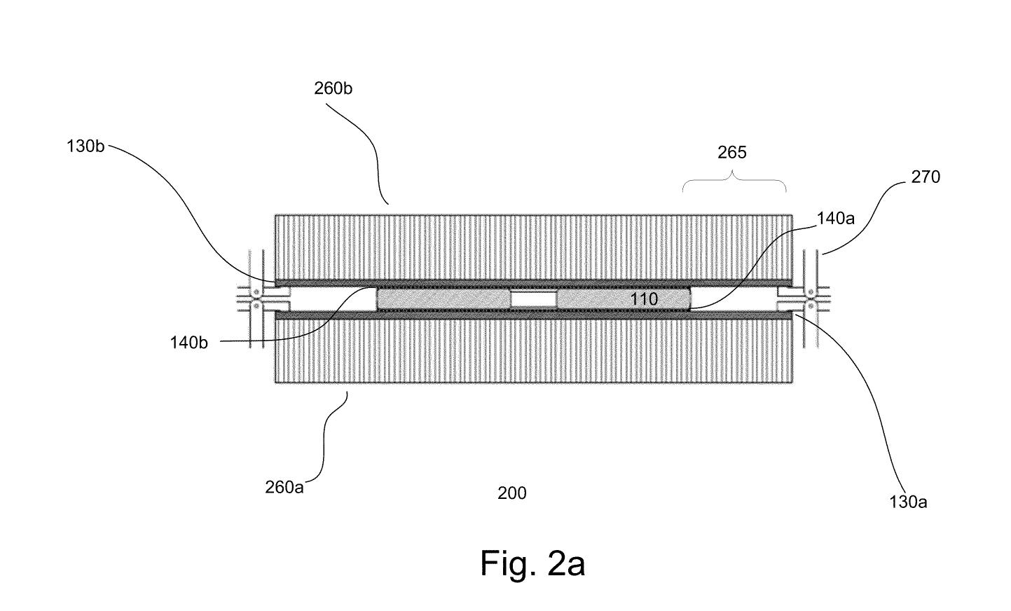

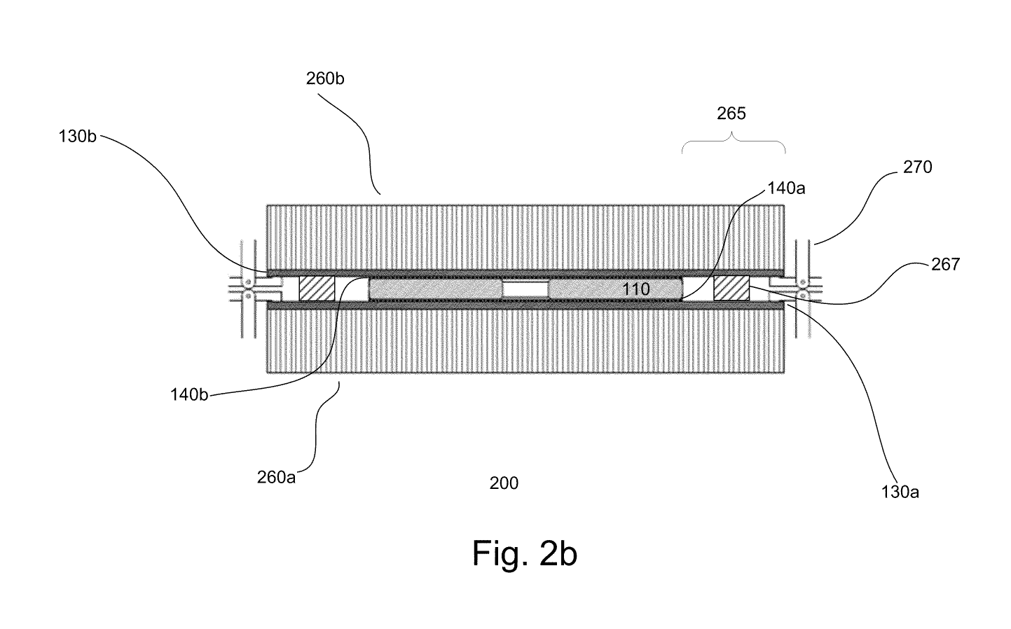

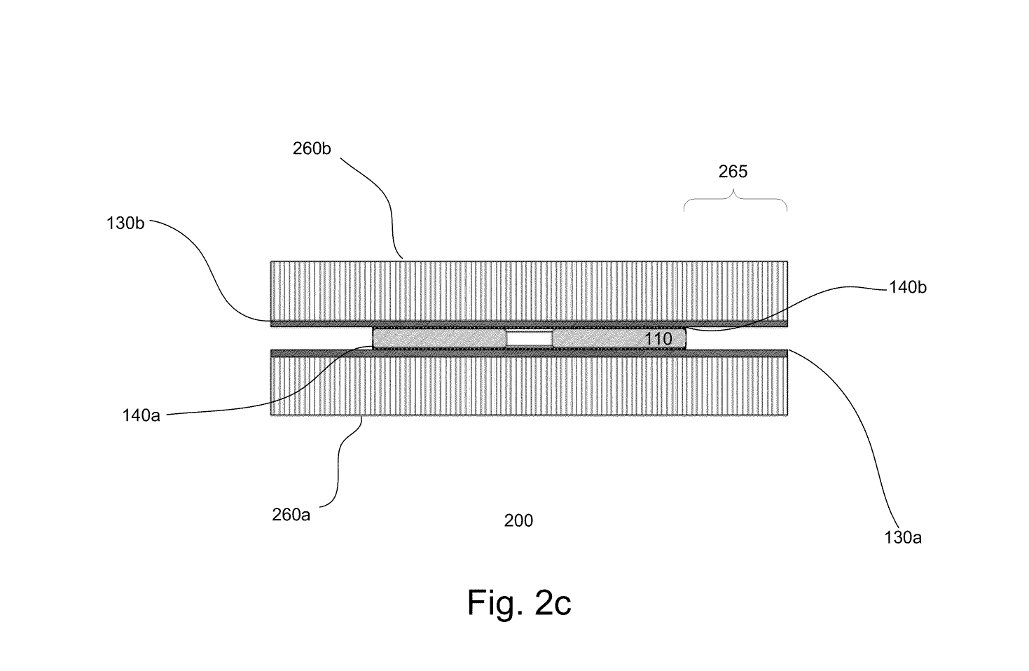

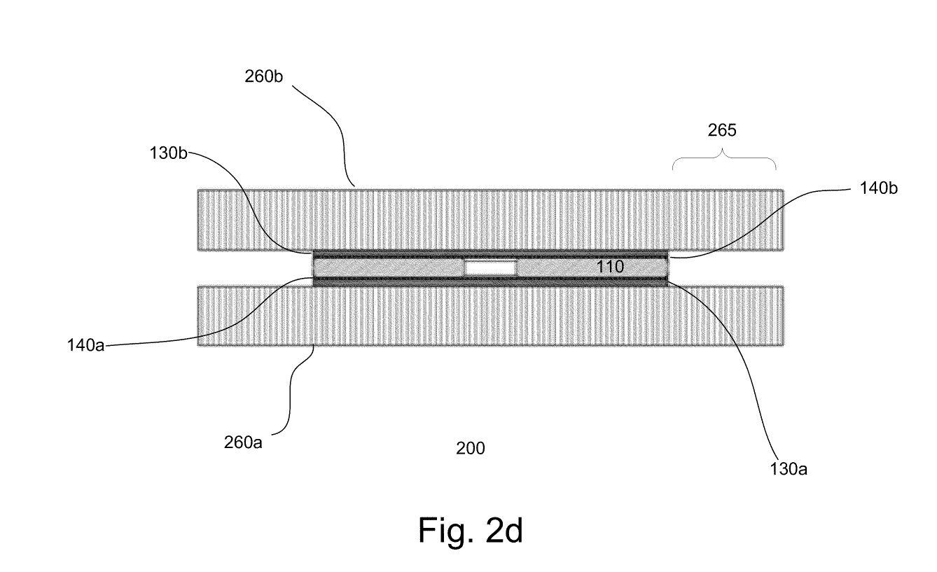

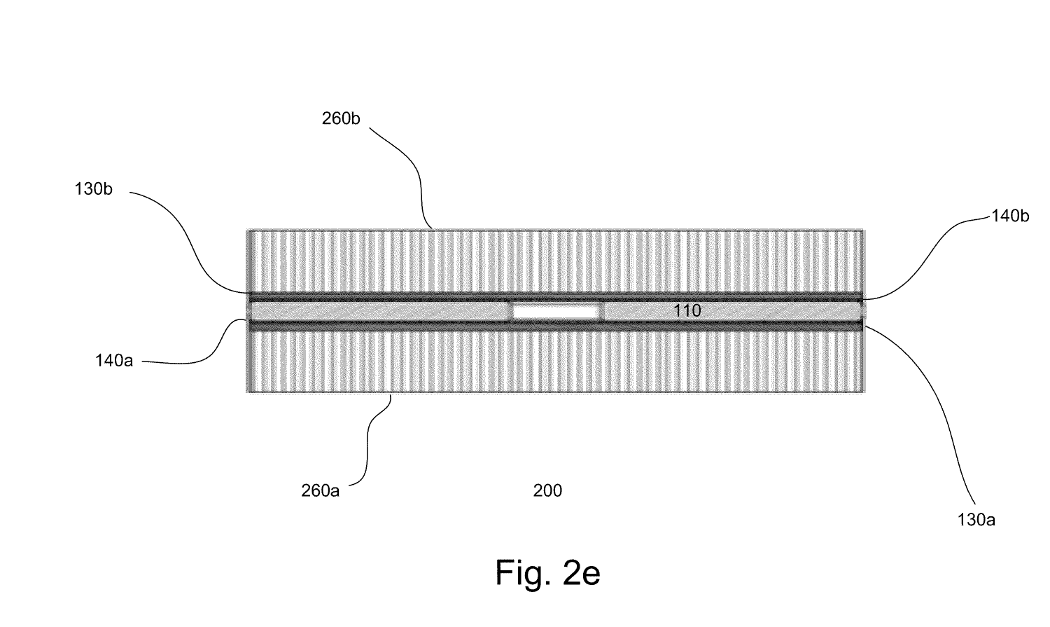

FIGS. 2a-e show various embodiments of a mold unit 200 of a printing system. Referring to FIG. 2a, the mold unit includes first and second mold bases 260a-b for holding first and second molds 130a-b. The mold bases preferably comprise a transparent material, such as quartz, to facilitate curing of the resist using, for example, UV. Forming the mold bases with other types of materials may also useful.

Disposed between the mold bases and molds is a disk 110. The mold bases press the molds against the surfaces of a disk to transfer the pattern of the molds to the resist 140a-b. The mold bases, for example, comprise a circular shape similar to that of the disk. Providing mold bases with other geometric shapes are also useful. The mold bases should be at least the same size as the molds. Providing mold bases which are larger than the molds is also useful. In one embodiment, the mold base and mold are larger than the disk to be imprinted. As shown, the mold bases and molds are the same size and extend beyond the edge of the disk, creating an extension region 265.

In one embodiment, supports 270 are provided to maintain the molds to their respective mold bases. For example, the supports maintain the molds to their respective mold bases when the mold bases are separated prior to pressing or imprinting. Various types of supports may be used. For example, the supports maybe hinged supports which maintain the molds to the mold bases in the extension region. Additionally, as shown in FIG. 2b, a spacer ring 267 can be disposed in the extension region to provide separation between the molds. Other types of supports or techniques may be employed to maintain the molds to the mold bases. For example, as shown in FIG. 2c, no supports are provided. The molds may be maintained to the mold bases by, for example, vacuum pressure.

FIG. 2d shows another embodiment in which the mold bases 260a-b extend beyond the edge of the disk 110 while the molds 130a-b are about the same size as the disk. In other embodiments, as shown in FIG. 2e, the mold bases 260a-b and molds 130a-b are about the same size as the disk 110. Other configurations of molds and mold bases may also be useful. For example, the mold bases extend beyond the edge of the disk 110 while the molds are between the size of the disk and mold bases.

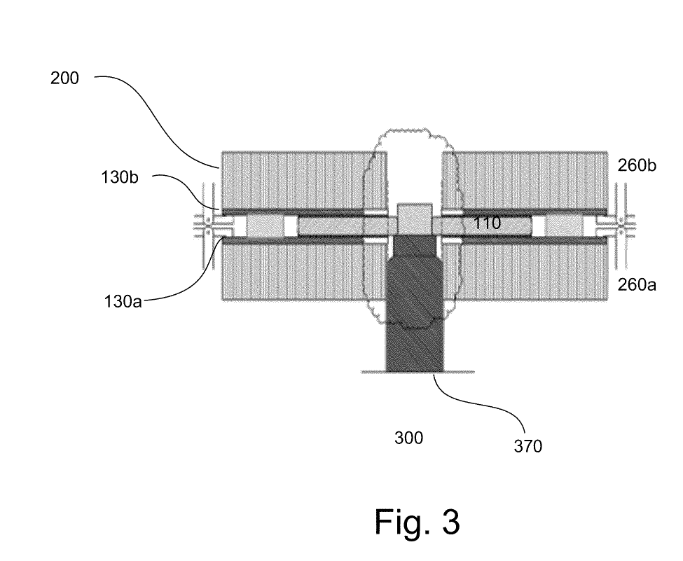

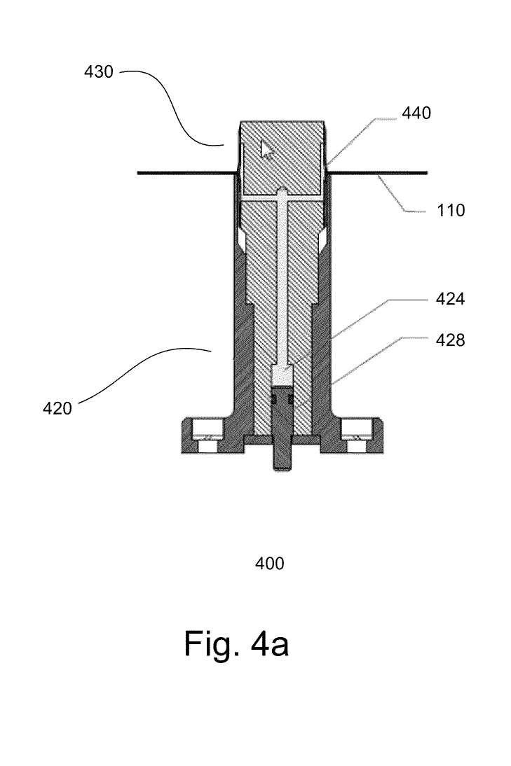

FIG. 3 shows an embodiment of a concentric alignment unit for a printing system. The alignment unit aligns the disk in the mold unit 200. In one embodiment, the alignment unit comprises a chuck 370 to provide concentric alignment of the disk to the molds. As shown, the chuck holds a disk in place during imprinting by the mold unit. In one embodiment, the chuck passes through the lower mold base 260a and mold 130a. The upper mold base 260b and mold 130b also include an opening to accommodate the chuck when the mold bases press the molds to imprint the surfaces of the disk. Various types of chucks may be employed.

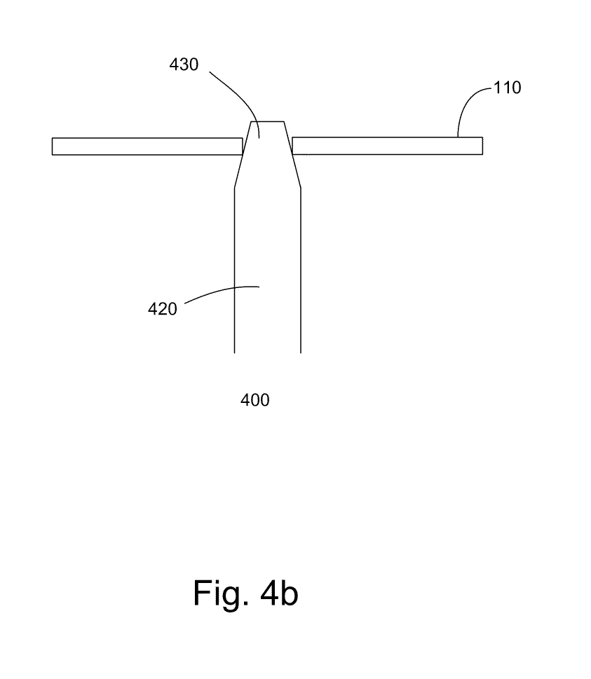

FIG. 4a shows an embodiment of a hydraulic expansion chuck 400. The chuck comprises a cylindrical body 420. Within the body is channel 424 containing hydraulic oil. A piston 428 is provided in communication with the channel. An expansion sleeve 440 is disposed at a tip portion 430 of the chuck. When a disk 110 is placed at the tip of the chuck, the piston is actuated. This increases the oil pressure in the channel, which, in turn, causes the sleeve to expand, holding the disk in place.

FIG. 4b shows another embodiment of a chuck for the alignment unit. As shown, the chuck comprises a cylindrical body 420 with a tapered end portion 430. The base of the end portion is designed to be larger than the opening of a disk 110. When a disk is placed on the end, it stops at the part where the end portion is larger than the opening. The use of a tapered end provides self alignment of the disk to the molds.

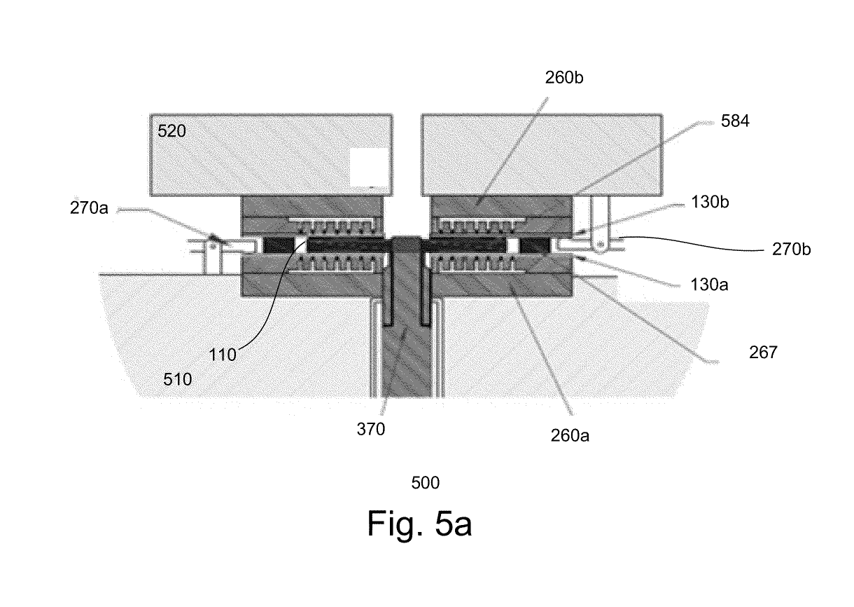

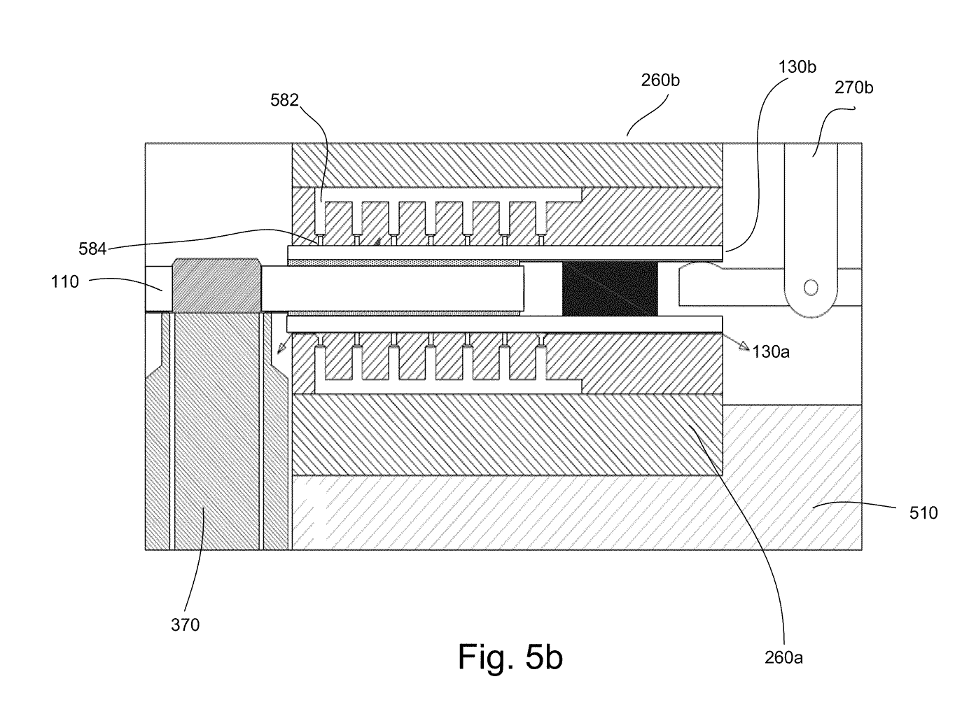

FIGS. 5a-b show portions of a mold assembly 500 in detail. The mold assembly includes lower and upper mold bases 260a-b for supporting lower and upper molds 130a-b. The mold bases preferably comprise a transparent material, such as quartz, to facilitate curing of the resist using, for example, UV ray. Forming the mold bases with other types of materials may also be useful.

In one embodiment, the lower mold base is attached to an assembly base 510 and the upper mold base is attached to an upper assembly support 520. Assembly guides (not shown) may be provided. The guides, for example, are attached to the assembly base and configured to enable the upper assembly support to slidably move up and down the guides away from or towards the assembly base. Lower mold supports 270a may be provided to temporarily hold the mold to the lower mold base. The lower mold supports, for example, are attached to the assembly base. Upper mold supports 270b are attached to the upper assembly support for holding the upper mold temporarily to the upper mold base.

The surface of the mold base on which is the mold is held includes grooves 582 with holes 584. Air supplied from an air source to the grooves through the holes produces an air film between the mold and mold base during imprinting. This exerts pressure on the mold. By providing the surface with the appropriate groove and hole pattern, the desired pressure profile can be produced to cause the mold to fully or conformally contact the surface of the disk for even imprinting. Furthermore, the air pressure prevents any lateral movement of the mold during imprinting, ensuring the integrity of the pattern formed.

A chuck 370 is disposed through the assembly base for aligning the disk to the molds for imprinting. The chuck slidably moves up and down the base in a direction parallel to, for example, the assembly guides. This facilitates mounting the molds to the mold base and disk for imprinting.

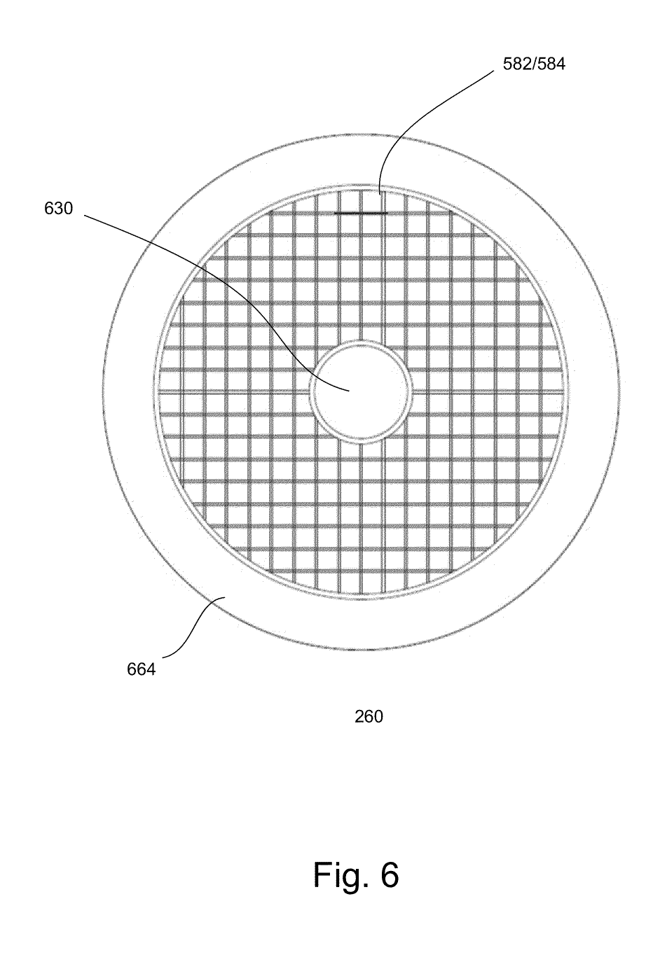

FIG. 6 shows an embodiment of a mold base 260. As shown, the mating surface 664 to which a mold is mated comprises grooves and holes 582 and 584. The holes are coupled to an air source through an air inlet. In one embodiment, the grooves and holes are configured to produce the desired pressure profile on the mold. The grooves and holes, for example, can be configured in a grid pattern. Providing the mold base with other types of groove and hole patterns are also useful. In the center of the mold base is an opening 630 to accommodate the chuck.

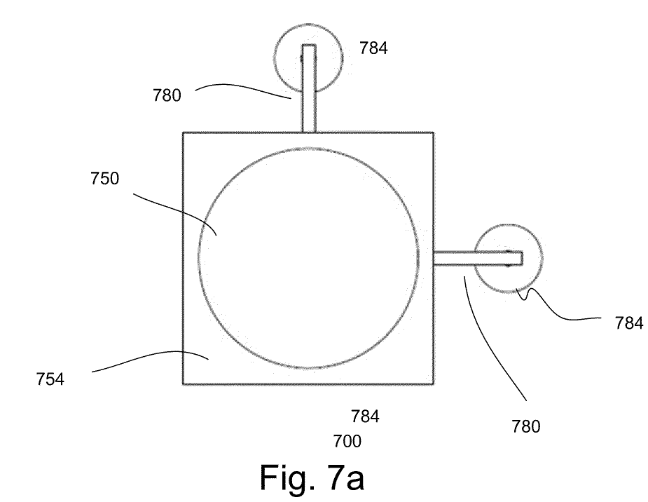

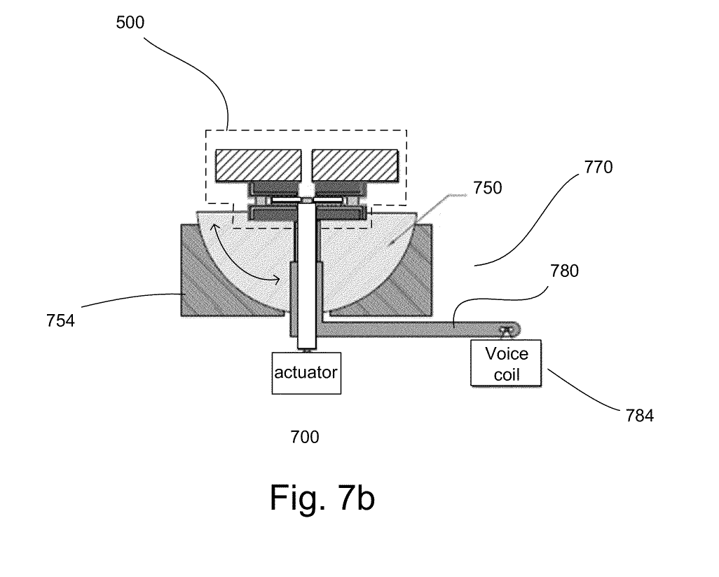

FIGS. 7a-b show top and cross-sectional views of an embodiment of the patterning system 700. As shown, the system includes a mold alignment unit 770. The mold alignment unit comprises an air bearing system 750. The bearing system includes a semi-spherical air bearing fitted to a bearing housing. The planar surface of the air bearing serves as an assembly base for the mold assembly unit 500 on which the lower mold base is mounted. When air is loaded into the bearing system, an air gap is formed between the bearing housing and bearing, causing the bearing to float. Due to the semi-spherical shape, the bearing can rotate. Rotational limiters may be provided to limit the amount which the bearing can rotate. In one embodiment, the planar surface of the bearing can tilt about +/− 1.5° from the horizontal plane. Other amounts of rotation by the bearing may also be useful.

The alignment unit further comprises first and second alignment arms 780 disposed 90° with respect to each other. The alignment arms serve as fulcrums. An aligner is provided to control movement of the alignment arms. In one embodiment, the aligner comprises a voice coil. When the aligner senses that the planar surface of the bearing has moved from the horizontal plane, the aligner is actuated to move it back into position. Furthermore, since the upper and lower molds are linked, the mold assembly is self-aligning.

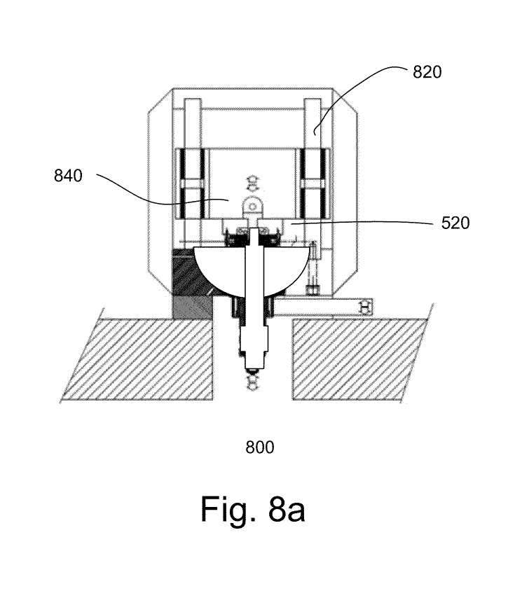

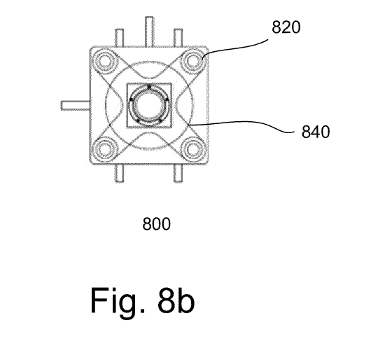

FIGS. 8a-b show cross-sectional and top views of an upper mold assembly 800. As shown, the upper mold assembly comprises an upper base support 840. Attached to the upper base support is the upper assembly mold support 520 to which the upper mold base is mounted. The upper base support is slidably mounted to assembly guides 820. As such, the guides facilitate the movement of the upper mold base towards or away from the lower mold base.

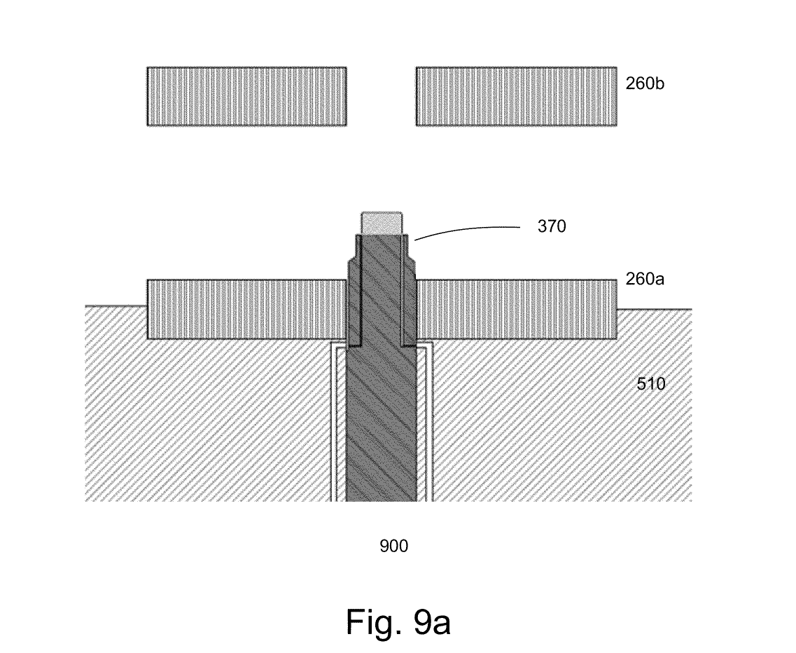

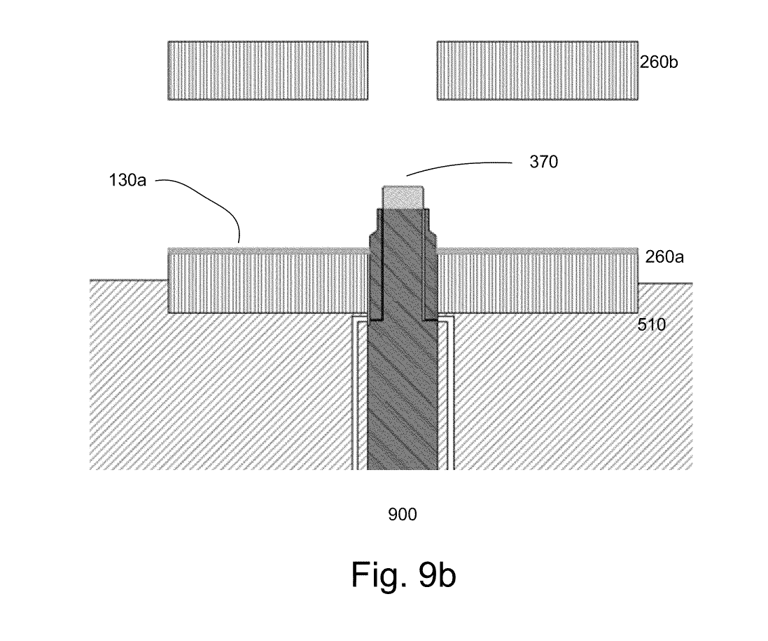

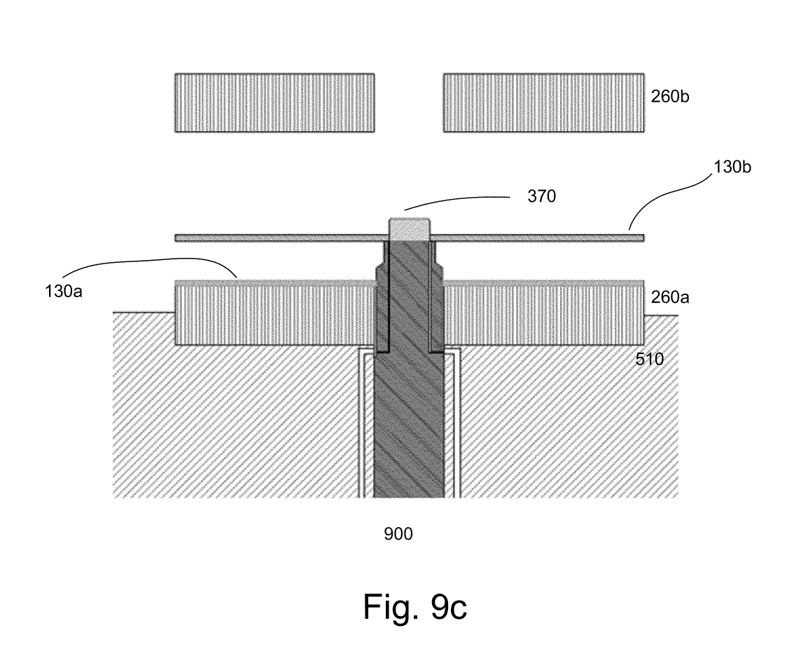

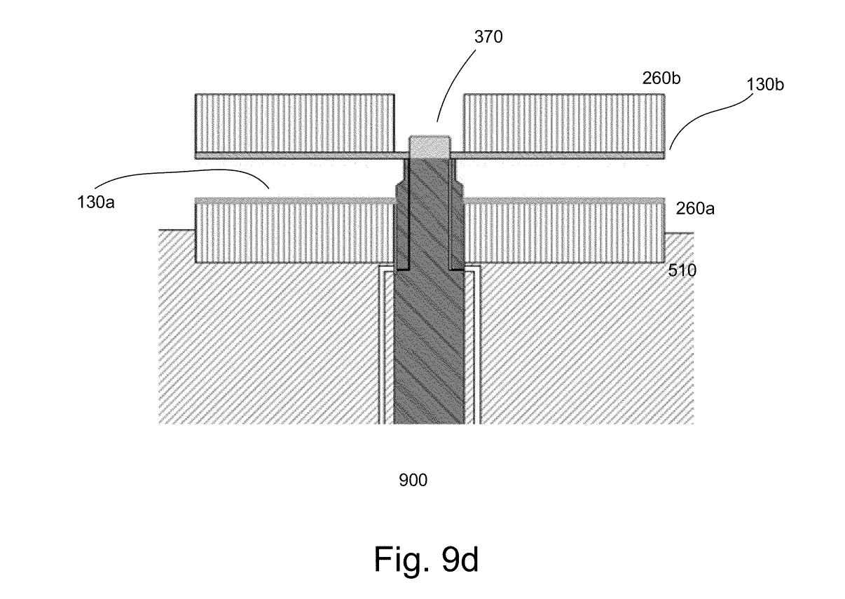

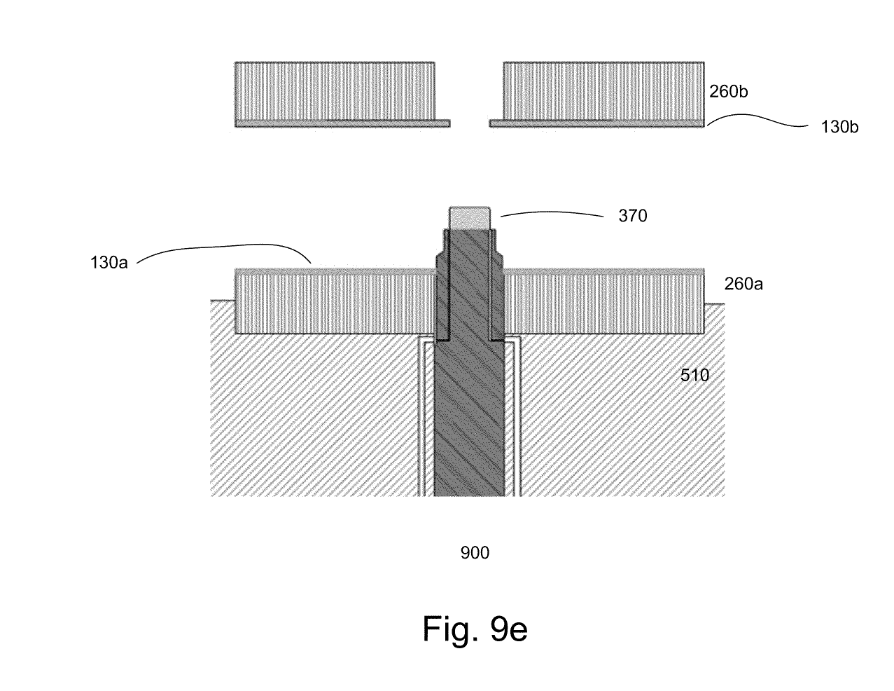

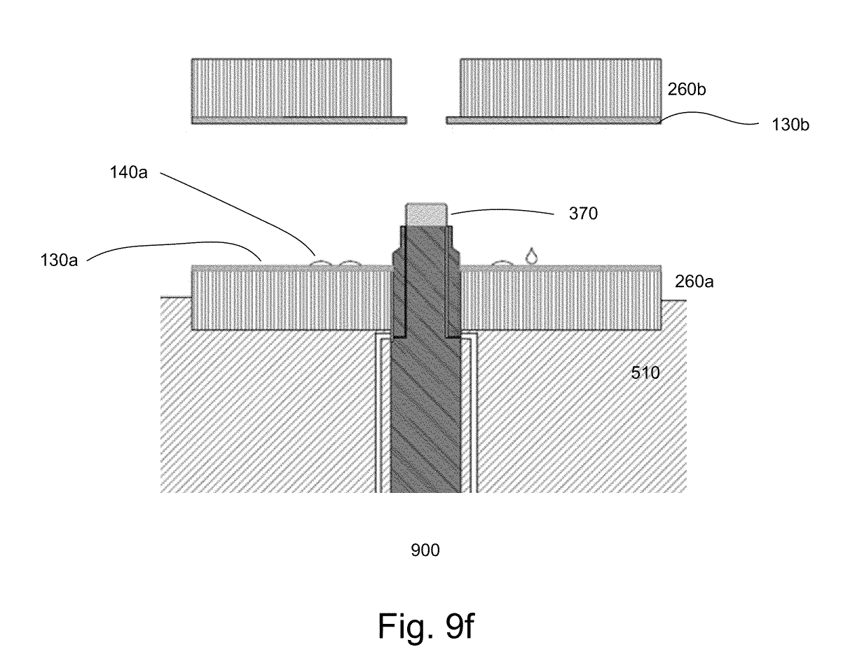

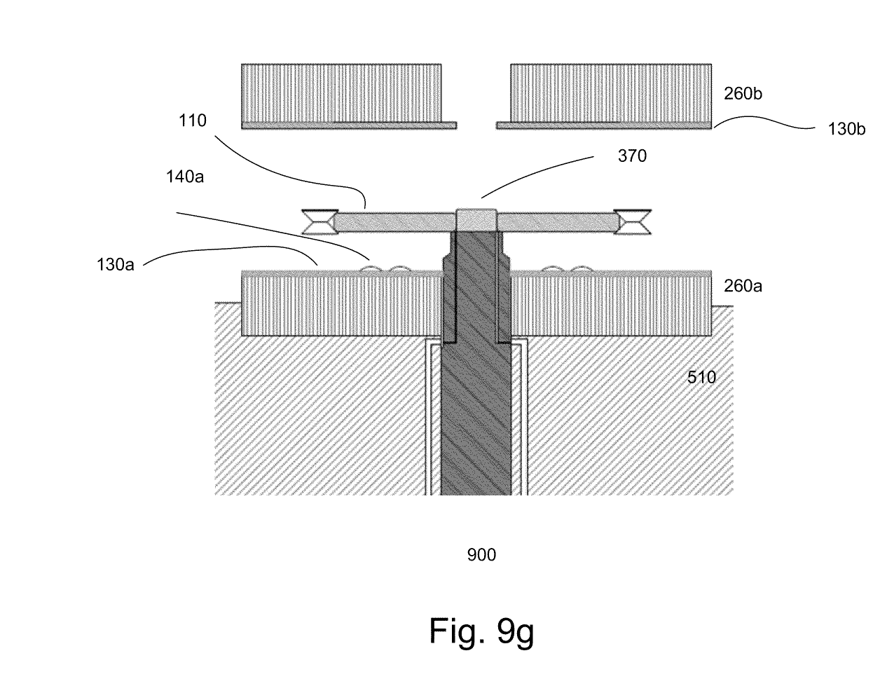

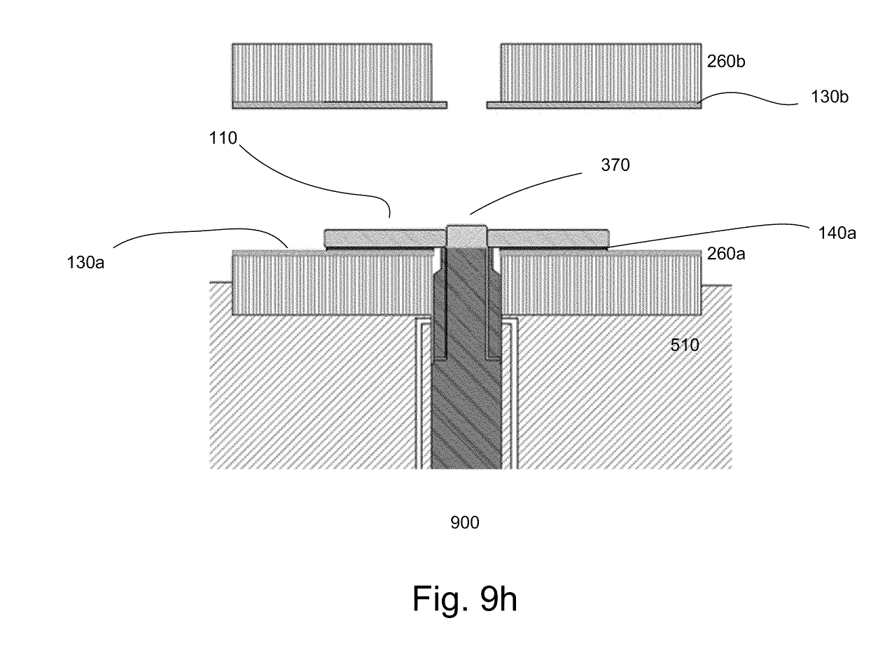

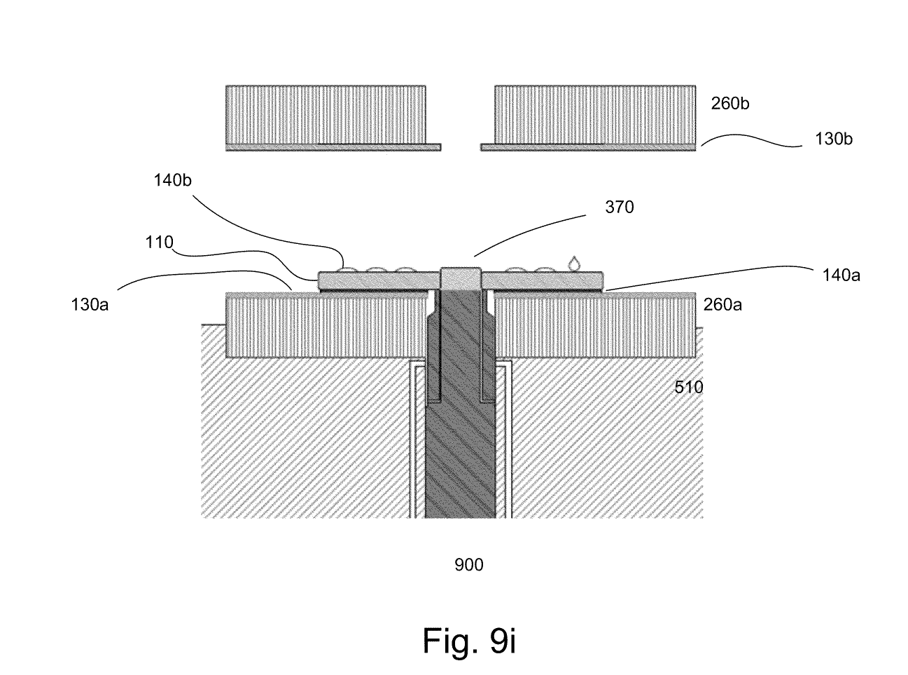

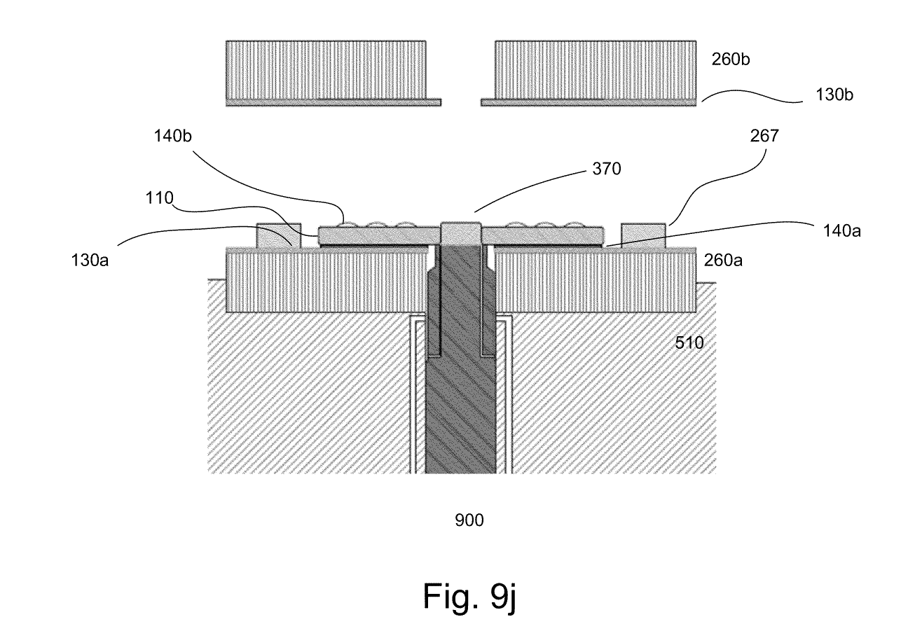

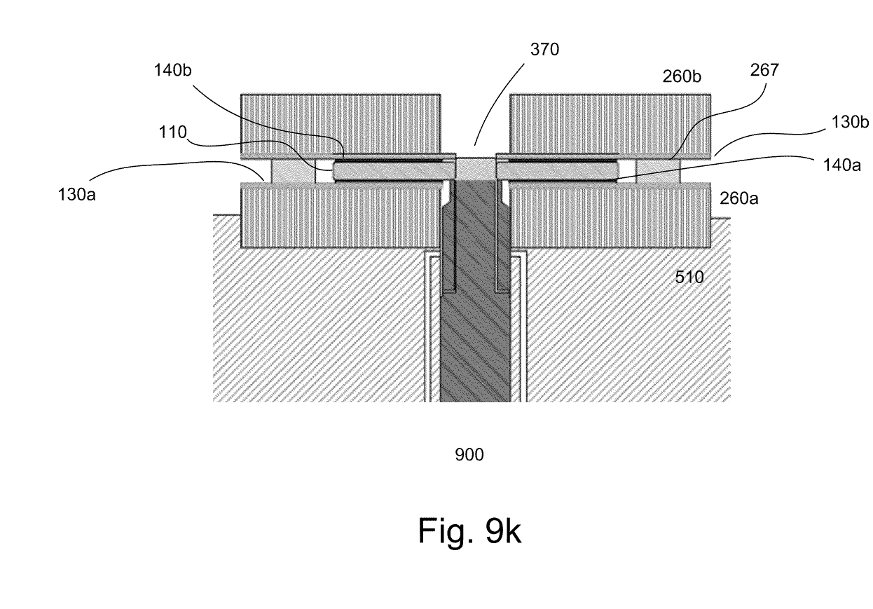

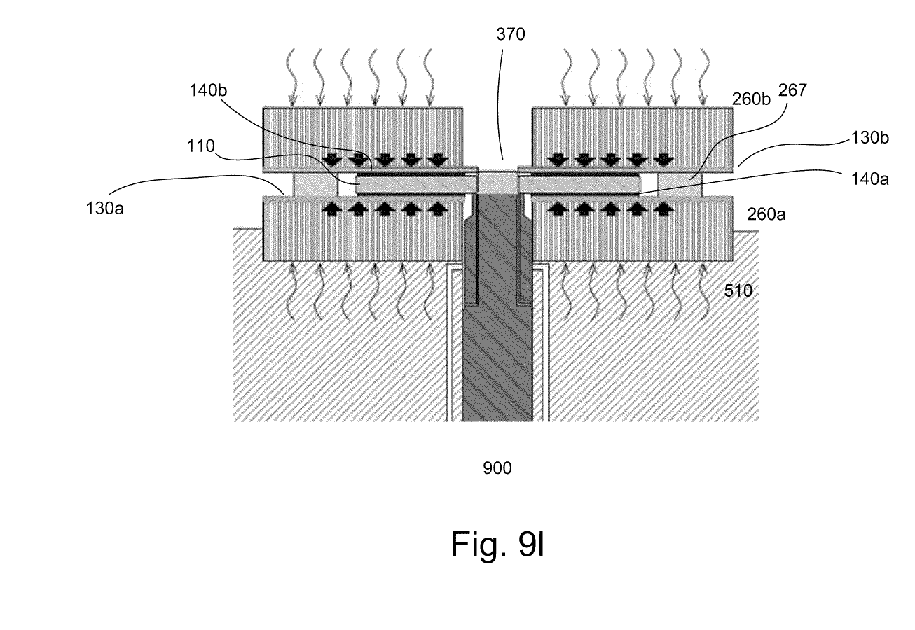

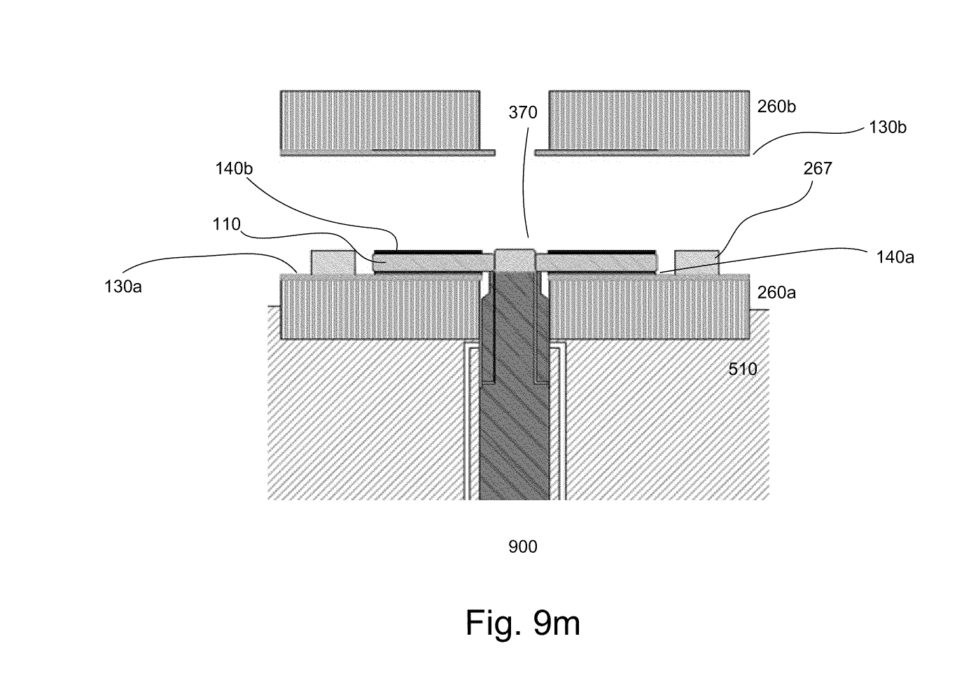

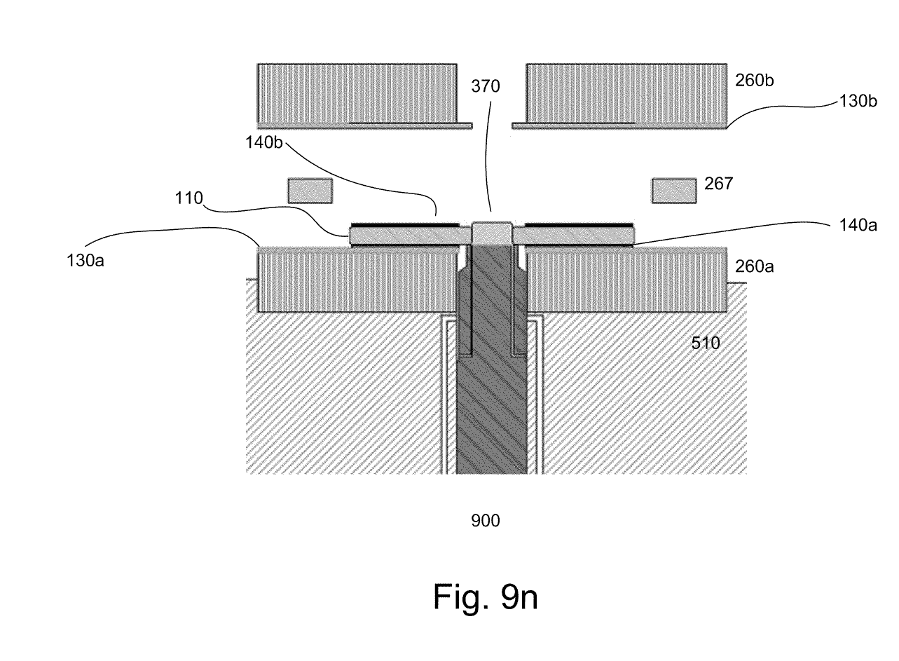

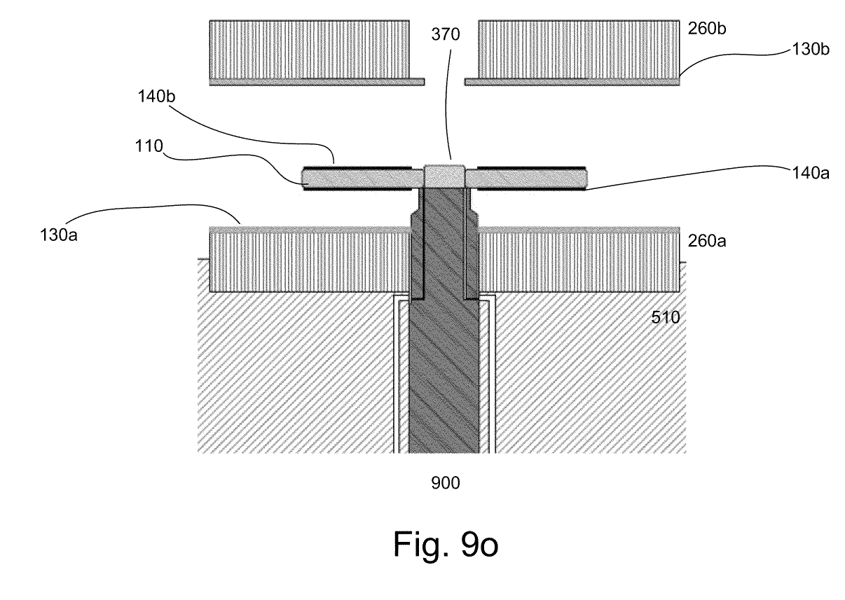

FIGS. 9a-o show cross-sectional views of an embodiment of a patterning process 900. Referring to FIG. 9a, a simplify view of a mold assembly 500 is shown. The mold assembly includes lower and upper mold bases 260a-b. The upper mold base is separated from the lower mold base. For example, the upper assembly support (not shown) is moved upwards or away from the assembly base 510. A chuck 370 is raised above the lower mold base.

In FIG. 9b, a lower mold 130a is loaded onto the lower mold base. The lower mold comprises an opening which allows the lower mold to pass through the chuck. The patterned surface of the lower mold faces the upper mold base. An upper mold is loaded onto the chuck, as shown in FIG. 9c. Unlike the lower mold, the opening of the upper mold is smaller to restrict it from passing through, leaving it suspended on the chuck. The patterned surface of the upper mold faces the lower mold base.

In one embodiment, as shown in FIG. 9d, the upper mold base is lowered until it contacts the upper mold. Alternatively, the chuck may be raised to cause the upper mold to contact the upper mold base. Moving both the chuck and upper mold base may also be useful. When the mold base contacts the mold, vacuum pressure is switched on, causing the upper mold to temporarily mate to the upper mold base. An upper mold support may be used in lieu or in addition to the vacuum pressure to mate the upper mold to the upper mold base.

Referring to FIG. 9e, the upper mold base with the upper mold is raised sufficiently for further processing. The lower mold is dosed with a transfer medium in FIG. 9f. In one embodiment, the lower mold is dosed with resist. The dose should be sufficient to result in the surface of the disk being completely covered during imprinting.

As shown in FIG. 9g, a disk 110 is loaded onto the chuck. In FIG. 9h, the chuck is lowered until the disk contacts the lower mold. The exposed surface of the disk is dosed with the transfer medium in FIG. 9i. In one embodiment, a spacer ring 267 is disposed in the extension region 265, as illustrated in FIG. 9j. Referring to FIG. 9k, the upper mold base and mold are lowered until they contact the spacer ring.

In FIG. 9l, air supply to the mold bases is switched on, exerting pressure on the molds against the surfaces of the disk. In one embodiment, a curing source is also switched on to cure the transfer medium. In one embodiment, curing sources are provided to cure the transfer medium from below and above the mold bases. In one embodiment, the curing source comprises a UV source.

After curing is completed, the process continues to effect the removal of the disk from the printing system. For example, the upper mold base is raised, as shown in FIG. 9m, followed by the removal of the spacer ring in FIG. 9n. In FIG. 9o, the chuck is raised to elevate the disk away from the lower mold, enabling the removal of the disk from the system.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A method of patterning an article comprising:
providing an article;
providing a mold with first and second surfaces, the first surface comprising a pattern;
providing a transfer medium between the mold and a surface of the article; and
pressing the mold against the surface of the article with air pressure, wherein a thickness of the mold enables the air pressure to cause the mold to contact the surface to produce an even pattern.

2. A method of patterning an article;
providing a substrate having a first surface;
providing a mold with first and second surfaces, the first surface comprising a pattern;
providing a transfer medium between the mold and a first surface; and
pressing the mold against the first surface with air pressure, wherein a thickness of the mold enables the air pressure to cause the mold to contact the first surface to produce an even pattern.

3. A patterning system comprising:
a first mold base having a first mating surface for mating to a first mold, wherein the first mating surface comprises first groove and hole pattern;
a first air inlet coupled to the first groove and hole pattern;
a second mold base having a second mating surface for mating to a second mold, wherein the second mating surface comprises second groove and hole pattern;
a second air inlet coupled to the second groove and hole pattern; and
wherein when air is supplied to the first and second inlets, the first and second groove and hole patterns generate a desired pressure profile on the first and second molds when mated to the first and second mating surfaces.
